(19) United States
(12) Patent Application Publication
(10) Pub. No.: US 2011/0151351 A1
(43) Pub. Date: Jun. 23, 2011

(54) MEMBRANE ELECTRODE ASSEMBLIES INCLUDING MIXED CARBON PARTICLES

(75) Inventor: Andrew T. HAUG, St. Paul, MN (US)

(73) Assignee: 3M Innovative Properties Company

(21) Appl. No.: 12/976,303

(22) Filed: Dec. 22, 2010

Related U.S. Application Data
(60) Provisional application No. 61/288,950, filed on Dec. 22, 2009.

(51) Int. Cl. H01M 8/04; H01M 8/10

(52) U.S. Cl. 429/480

(57) ABSTRACT

Gas permeable layers in fuel cell membrane electrode assemblies are provided which comprises a mixture of first and second types of carbon particles, which may provide relatively hydrophilic and relatively hydrophobic pathways. In some embodiments, the first type of carbon particle oxidizes at a lower rate than said second type of carbon particle. In some embodiments, the first type of carbon particle is graphitized and the second type of carbon particle is not graphitized.

### CROSS REFERENCE TO RELATED APPLICATION

This application claims the benefit of U.S. Provisional Patent Application No. 61/288950, filed December 22, 2009, the disclosure of which is incorporated by reference herein in its entirety.

This invention was made with Government support under Cooperative Agreement DE-FG36-07GO17007 awarded by DOE. The Government has certain rights in this invention.

### FIELD OF THE DISCLOSURE

This disclosure relates to gas permeable layers in fuel cell membrane electrode assemblies which comprise a mixture of first and second types of carbon particles, which may provide relatively hydrophilic and relatively hydrophobic pathways.

### SUMMARY OF THE DISCLOSURE

Briefly, the present disclosure provides a fuel cell membrane electrode assembly (MEA) comprising at least one gas permeable layer comprising a mixture of first and second types of carbon particles in a weight ratio of between 99:1 and 5:95, wherein said first type of carbon particle oxidizes at a lower rate than said second type of carbon particle. In some embodiments, the first type of carbon particles is graphitized carbon particles. In some embodiments, the second type of carbon particle is not graphitized carbon particles. In some embodiments, the MEA comprises the first and second types of carbon particles in a weight ratio of not more than 95:5. In some embodiments, the MEA comprises the first and second types of carbon particles in a weight ratio of at least 50:50. In some embodiments, the first type of carbon particle has a surface area of between 10 and 200 m²/g. In some embodiments, the second type of carbon particle has a surface area of between 200 and 1000 m²/g. In some embodiments, the gas permeable layer is a catalyst-containing cathode layer, a catalyst-containing anode layer, a gas diffusion layer (GDL) or a gas flowfield plate.

### DETAILED DESCRIPTION

The present disclosure provides a fuel cell membrane electrode assembly comprising at least one gas permeable layer comprising a mixture of two different types of carbon particles.

### Membrane Electrode Assemblies

A membrane electrode assembly (MEA) or polymer electrolyte membrane (PEM) according to the present disclosure may be useful in an electrochemical cell such as a fuel cell. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts, typically including platinum metal. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA. The terms “electrode layer” and “catalyst layer” are used interchangeably as used herein.

The PEM according to the present disclosure may comprise any suitable polymer electrolyte. The polymer electrolytes useful in the present disclosure typically bear anionic functional groups bound to a common backbone, which are typically sulfonate groups (forming sulfonic acid groups when neutralized by protons) but may also include carboxylate groups (forming carboxylic acid groups when neutralized by protons), deprotonated imide groups, deprotonated sulfonamide groups, and deprotonated amide groups, or other functional groups that form acids with protonated. The polymer electrolytes useful in the present disclosure typically are highly fluorinated and most typically perfluorinated. The polymer electrolytes useful in the present disclosure are typically copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less and more typically 1100 or less. In some embodiments, polymers of unusually low EW can be used, typically 1000 or less, more typically 900 or less, and more typically 800 or less, often with improved performance in comparison to the use of higher EW polymer.

The polymer can be formed into a membrane by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 130° C. or higher, most typically 150° C. or higher. In some embodiments of the method according to the present disclosure, additives are added to the membrane only after annealing and not before, and therefore annealing conditions are not impacted by their presence, which may, e.g., raise membrane Tg, thus necessitating higher annealing temperatures. The PEM typically has a thickness of less than 50 microns, more typically less than 40 microns, more typically less than 30 microns, and most typically about 25 microns.

A PEM according to the present disclosure may additionally comprise a porous support, such as a layer of expanded PTFE or the like, where the pores of the porous support contain the polymer electrolyte. A PEM according to the present disclosure may comprise no porous support. A PEM according to the present disclosure may comprise a crosslinked polymer.

To make an MEA or CCM, catalyst may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Any suitable catalyst may be used in the practice of the present disclosure.

Typically, carbon-supported catalyst particles are used. Typical carbon-supported catalyst particles are 50-90% carbon and 10-70% catalyst metal by weight, the catalyst metal typically comprising Pt for the cathode and anode. In some embodiments, the catalyst metal comprises Pt and Ru in a weight ratio of between 1:2 and 4:1 for the anode. Typically, the catalyst is applied to the PEM or to the FTL in the form of a catalyst ink. Alternately, the catalyst ink may be applied to a transfer substrate, dried, and thereafter applied to the PEM or to the FTL as a decal. The catalyst ink typically comprises polymer electrolyte material, which may or may not be the same polymer electrolyte material which comprises the PEM. The catalyst ink typically comprises a dispersion of catalyst particles in a dispersion of the polymer electrolyte. The ink typically contains 3-40% solids (i.e. polymer and catalyst) and more typically 10-25% solids. The electrolyte dispersion is typically an aqueous dispersion, which may additionally contain alcohols and polyalcohols such a glycerin and ethylene glycol. The water, alcohol, and polyalcohol content may be adjusted to alter rheological properties of the ink. The ink typically contains 0-75% alcohol and 0-20% polyalcohol. In addition, the ink may contain 0-2% of a suitable dispersant. The ink is typically made by stirring with heat followed by dilution to a coatable consistency.

To make an MEA, GDL's may be applied to either side of a CCM by any suitable means. Any suitable GDL may be used in the practice of the present disclosure. Typically the GDL is comprised of sheet material comprising carbon fibers. Typically the GDL is a carbon fiber construction selected from woven and non-woven carbon fiber constructions. Carbon fiber constructions which may be useful in the practice of the present disclosure may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

In use, the MEA according to the present disclosure is typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

### Mixed Carbon Particles

The present disclosure provides a fuel cell membrane electrode assembly comprising at least one gas permeable layer comprising a mixture of two different types of carbon particles. In some embodiments the two types of carbon particles oxidize at different rates resulting in a structure mixing discrete hydrophilic and hydrophobic regions. It is believed that such a structure may offer the benefit of good and tailorable water transport capabilities while maintaining good gas transport and electrical capabilities. In some embodiments, a first type of carbon particle is graphitized, and a second type of carbon is not graphitized. During fuel cell operation, high potential (typically above 1.2V vs. a hydrogen reference) may be applied, which is sufficient to oxidize the non-graphitized carbon, rendering it hydrophilic. Graphitized carbon has a much lower oxidation rate than non-graphitized carbon, and is therefore expected to remain hydrophobic.

In some embodiments, the first type of carbon particle has a surface area of less than 200 m²/g, typically between 10 and 200 m²/g, more typically between 30 and 150 m²/g, and more typically between 50 and 100 m²/g. In some embodiments, the second type of carbon particle has a surface area of greater than 200 m²/g, typically between 200 and 1000 m²/g, more typically between 300 and 1000 m²/g, and more typically between 400 and 1000 m²/g. surface areas are typically measured by BET method (Brunauer, Emmett, Teller method). In various embodiments, the carbon particles of the first type may be superficially graphitized, graphitized throughout, or graphitized to an intermediate degree.

A tailored two-carbon material according to the present disclosure may achieve good water transport and gas transport properties simultaneously. After oxidation, the dual carbon material creates discrete zones of liquid water and gas transport, achieving both good gas and liquid water transport. Upon oxidation, the dual layer carbon material can reach a state in which the non-graphitized material is oxidized, creating hydrophilic zones allowing easy water transport. Gas, however, could still easily transport through other areas of the material.

In some embodiments the first and second types of carbon particles are mixed to form an intimate blend before inclusion in an MEA layer. In some embodiments, each type is separately formed into a mass, e.g., by casting and drying, and then ground into particles of a desired size which are thereafter mixed to form a blend before inclusion in an MEA layer.

In some embodiments the weight ratio of the first and second types of carbon particles is not more than 99:1, in some embodiments not more than 95:5, and in some embodiments not more than 90:10. In some embodiments the weight ratio of the first and second types of carbon particles is at least 5:95, in some embodiments at least 25:75, in some embodiments at least 50:50, and in some embodiments at least 75:25.

In some embodiments, the second type of carbon is oxidized during use in a fuel cell. In some embodiments, the second type of carbon is oxidized in a special step after incorporation in a fuel cell stack, such as by application of an electrical potential from an external source to the fuel cell. In some embodiments, the second type of carbon is oxidized after incorporation into an MEA but before incorporation into a fuel cell stack, e.g., by one or more of the following methods: by acid washing, by application of high potential, or by surface modification. In some embodiments, the second type of carbon is oxidized before incorporation into an MEA, e.g., by one or more of the following methods: by acid washing, by application of high potential, or by surface modification.

### MEA Layers Including Mixed Carbon Particles

The present disclosure provides a fuel cell membrane electrode assembly comprising at least one gas permeable layer comprising a mixture of two different types of carbon particles. The gas permeable layer may be one or more of: a catalyst-containing cathode layer, a catalyst-containing anode layer, a cathode-side GDL, an anode-side GDL, cathode-side gas flowfield plate, an anode-side gas flowfield plate, or an added layer such as a sublayer between a catalyst-containing cathode layer and a PEM, a sublayer between a catalyst-containing anode layer and a PEM, an interlayer between a catalyst-containing cathode layer and a GDL, an interlayer between a catalyst-containing anode layer and a GDL, a microporous or other surface layer on a cathode-side GDL, a microporous or other surface layer on an anode-side GDL.

The gas permeable layer comprising a mixture of two different types of carbon particles may additionally comprise, as appropriate, a catalyst material such as a platinum-containing catalyst. The gas permeable layer comprising a mixture of two different types of carbon particles may additionally comprise, as appropriate, additional hydrophobic material, such as a fluoropolymer, such as PTFE, FEP or Teflon® AF.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A fuel cell membrane electrode assembly comprising at least one gas permeable layer comprising a mixture of first and second types of carbon particles in a weight ratio of between 99:1 and 5:95, wherein said first type of carbon particle oxidizes at a lower rate than said second type of carbon particle.

2. The fuel cell membrane electrode assembly according to claim 1 wherein said first type of carbon particles is graphitized carbon particles.

3. The fuel cell membrane electrode assembly according to claim 2 wherein said second type of carbon particle is not graphitized carbon particles.

4. The fuel cell membrane electrode assembly according to claim 1 comprising said first and second types of carbon particles in a weight ratio of not more than 95:5.

5. The fuel cell membrane electrode assembly according to claim 1 comprising said first and second types of carbon particles in a weight ratio of at least 50:50.

6. The fuel cell membrane electrode assembly according to claim 1 wherein the first type of carbon particle has a surface area of between 10 and 200 m²/g.

7. The fuel cell membrane electrode assembly according to claim 1 wherein the second type of carbon particle has a surface area of between 200 and 1000 m²/g.

8. The fuel cell membrane electrode assembly according to claim 1 wherein said at least one gas permeable layer is a catalyst-containing cathode layer.

9. The fuel cell membrane electrode assembly according to claim 1 wherein said at least one gas permeable layer is a catalyst-containing anode layer.

10. The fuel cell membrane electrode assembly according to claim 1 wherein said at least one gas permeable layer is a gas diffusion layer (GDL).

11. The fuel cell membrane electrode assembly according to claim 1 wherein said at least one gas permeable layer is a gas flowfield plate.
